(19) United States
(12) Patent Application Publication
(10) Pub. No.: US 2020/0298611 A1
(43) Pub. Date: Sep. 24, 2020

(54) DOUBLE-SIDED CLIPBOARD

(71) Applicant: Jerod Allen, Kansas City, KS (US)

(72) Inventor: Jerod Allen, Kansas City, KS (US)

(21) Appl. No.: 16/822,855

(22) Filed: Mar. 18, 2020

Related U.S. Application Data
(60) Provisional application No. 62/819,808, filed on Mar. 18, 2019.

(51) Int. Cl. B42F 9/00

(52) U.S. Cl. CPC B42F 9/001

(57) ABSTRACT

A double-sided clipboard includes first and second surfaces, with corresponding first and second paper securement clips on each side of the clipboard. In one exemplary embodiment, the first surface of the clipboard is generally flat for use in writing and free-hand sketching, the second surface includes a drawing guide comprised of a plurality of raised sections arranged to form line guides for facilitating precise drawing of horizontal and vertical lines. Other embodiments have writing surfaces on each side of the board, further embodiments have drawing guides on each side of the board and a plurality of securement clips.

### CROSS-REFERENCE TO RELATED APPLICATIONS

This application claims the benefit of U.S. Provisional Patent Application No. 62/819,808, filed Mar. 18, 2019, the disclosure of which is hereby incorporated herein in its entirety by reference.

### BACKGROUND OF THE INVENTION

### Field of the Invention

This invention relates to clipboards for writing and drawing.

### Description of the Related Art

Clipboards for securing a paper, documents, forms, and the like to allow a user to write or draw on the paper, are known in the art. Such clipboards are commonplace in office and industrial settings. Particularly in outdoor use, a clipboard allows a user to secure a form and take notes, fill out information, etc., with the form secured to the board. A typical clipboard comprises a flat writing surface (or “board”) on which a user places a piece of writing or drawing paper, with a spring-loaded clip attached towards one end of the writing surface and used to secure the paper against the board. While suitable for free-hand writing and sketching, the board does not provide any enhanced drawing features.

Drawing grids are also known in the art, with a writing surface comprised of multiple recessed lines and/or points formed in a generally flat surface. With a piece of paper placed over the writing surface, a user can draw straight lines by placing the tip of his or her writing instrument onto the paper, pressing the tip into the recessed line, and tracing the path of the recessed line to draw a straight line on the paper.

While clipboards and drawing grids are individually useful for their intended purposes, either one is not useful for the other purpose—i.e., a flat clipboard surface is not conducive or useful for accurate drawing of straight lines, and a textured surface with recessed line guides for drawing lines is not conducive or useful for writing or freehand sketching as the recessed lines under the paper interfere with that operation. Thus, a user wanting to annotate a line drawing made on a drawing grid typically must remove the paper from the drawing grid and place it on a flat surface such as a table or the ground in order to write, and a user wanting to add a line drawing to a paper on which he or she is writing must similarly transfer the paper to the drawing grid.

Thus, it can be seen that there remains a need in the art for an improved clipboard that overcomes the deficiencies of devices known in the art.

### SUMMARY OF THE INVENTION

The present invention is directed to a double-sided clipboard having first and second surfaces, with corresponding first and second paper securement clips configured such that a securement clip is on each side of the clipboard. The first and second surfaces are generally rectangular in shape and configured to be slightly larger than a corresponding standard sized piece of paper, such as 8½×11 inches, legal, A4, or other commonly-known paper sizes. First and second securement clips are attached at an end of the clipboard on each corresponding side, with the first clip positioned and configured to secure a piece of paper placed on the first surface, and the second clip positioned and configured to secure a piece of paper placed on the second surface.

In one exemplary embodiment, the first surface of the clipboard is generally flat and conducive for use in writing and free-hand sketching. The second surface of the clipboard comprises a drawing guide comprised of a plurality of raised sections arranged in an aligned grid pattern. Each raised section is formed as a compressed four-sided pyramidal shape, with the center of the square raised to a point where the four sides meet, with each side sloping downwardly to a bottom edge. With the raised sections arranged in a grid pattern, horizontal and vertical line paths are formed between adjacent sections. The line paths act to guide the point of a writing instrument along a paper placed over the surface to allow a user to draw straight horizontal and vertical lines using the line guide paths. In an alternative embodiment, the drawing guide comprises recessed guidelines for drawing circles or other geometric shapes.

In further alternative embodiments the first and second sides of the clipboard are flat surfaces, in other embodiments the first and second sides are comprised of flat surfaces, drawing guides, and combinations thereof. In further embodiments, the clipboard includes a plurality of securement clips, with more than one clip on at least one side of the clipboard.

### BRIEF DESCRIPTION OF THE DRAWINGS

FIG. 1 is a front perspective view of a double-sided clipboard in accordance with an exemplary embodiment of the present invention.

FIG. 2 is a rear perspective view of the double-sided clipboard of FIG. 1. showing the rear drawing grid side of the board.

FIG. 3 is a top plan view of a double-sided clipboard in accordance with an exemplary embodiment of the present invention.

FIG. 4 is a side view of the double-sided clipboard of FIG. 3.

FIG. 5 is a close-up partial view of a drawing grid of the double-sided clipboard of FIG. 2.

FIG. 6 is close-up, side cut-away view of a portion of the drawing grid of FIG. 5 with a piece of paper placed thereon.

### DETAILED DESCRIPTION OF EXEMPLARY EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, words such “upwardly,” “downwardly,” “rightwardly,”, “leftwardly”, “horizontally”, and “vertically” used herein refer to directions in the drawings to which reference is made. The words “inwardly” and “outwardly” refer to directions toward and away from, respectively, the geometric center of the embodiment being described and designated parts thereof. That terminology will include the words specifically mentioned, derivatives thereof and words of a similar import.

The present invention is directed to a double-sided clipboard having first and second surfaces, with corresponding first and second paper securement clips attached to an end of the corresponding surface to secure a piece of paper to the clipboard to allow writing or drawing thereon. In an exemplary embodiment, the first surface is generally flat and used for supporting and writing or sketching on a piece of paper attached to the surface by the first securement clip. The flat first surface allows a user to write, print, and free-hand draw. The second surface comprises a generally planar drawing guide comprised of a plurality of raised sections arranged in an aligned grid pattern. Each raised section is formed as a compressed four-sided pyramidal shape, with the center of the square raised to a point where the four sides meet, with each side sloping downwardly to a bottom edge. With the raised sections arranged in a grid pattern, horizontal and vertical line paths are formed between adjacent sections. The line paths act to guide the point of a writing instrument along a paper placed over the surface to allow a user, with a piece of paper secured to the second side over the drawing guide, to draw straight horizontal and vertical lines using the line guide paths which guide the point of a pencil, pen, or marker through the paper.

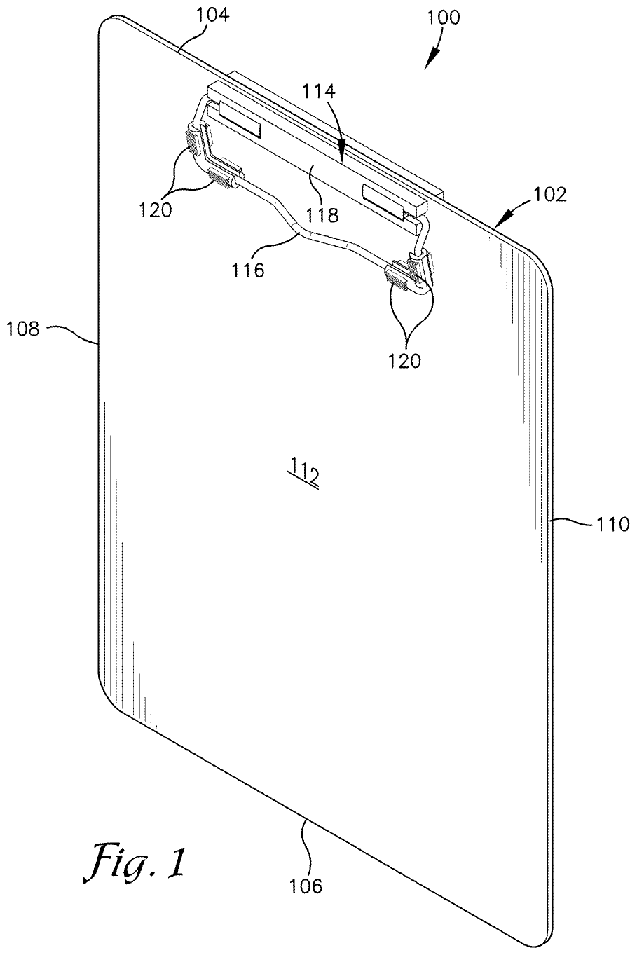

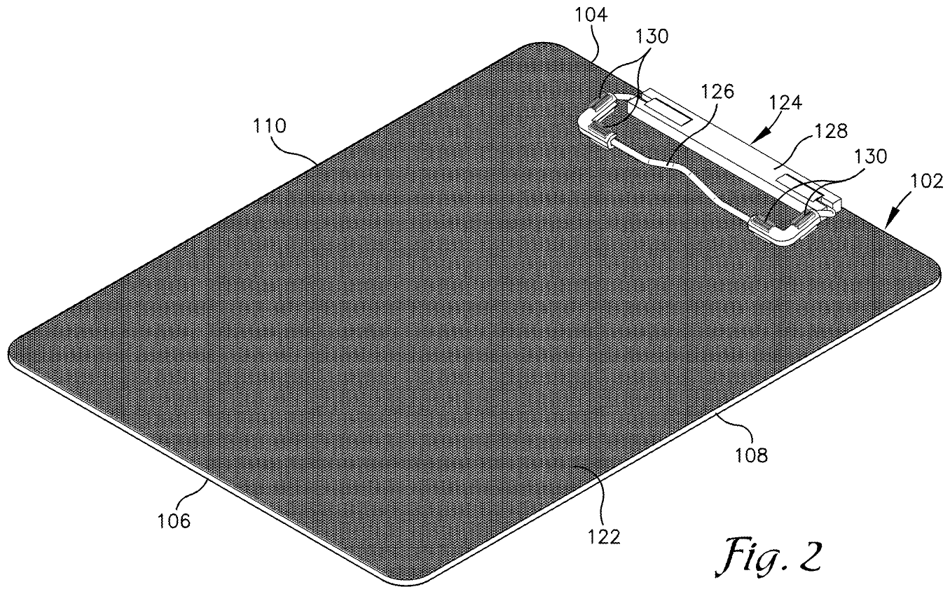

Looking to FIGS. 1 and 2, a double-sided clipboard in accordance with a first exemplary embodiment of the present invention is designated generally by numeral 100. Clipboard 100 comprises a generally flat and rectangular shaped rigid main body 102 having top 104, bottom 106, and side 108, 110 edges. The main body 102 is preferably made from a strong, rigid material such as a plastic or composite. In alternative embodiments the main body 102 may be fashioned from wood or metal.

The rectangular shape of the main body 102, with longer side edges 108, 110, and shorter top 104 and bottom 106 edges preferably conforms generally to the shape of a standard-sized drawing sheet or paper, such as common 8½×11 inch paper, A4 sized paper, or legal sized paper, with the size of the main body preferably being slightly larger overall in length and width than the paper with which it will be primarily used. For example, a clipboard for use with 8½×11 inch paper will preferably be sized 9×12 inches or larger to allow the paper to be easily placed onto the desired surface of the main body 102. It should be understood that the main body 102 may be sized to any desired size to accommodate paper sizes commonly used for particular applications. For example, the double-sided clipboard may be sized to conform to a smaller 5×8 inch paper, to a larger 8½×17 inch legal sized paper, or to any other desired size.

Looking to FIG. 1, the first surface 112 of the main body 102 is generally flat and smooth, allowing use of the clipboard for supporting a paper for writing and/or freehand drawing. A first securement clip 114 is attached to the main body 102 near the top edge 104. The first securement clip comprises a generally U-shaped arm 116 attached to a base 118. Base 118 includes a spring mechanism which biases the arm portion 116 against the first surface. In use, a user may raise the arm 116 by lifting it away from the board to overcome the spring bias, and place an end portion of a sheet of paper under the arm 116, then letting the arm fall so that the spring bias of the arm secures the paper to the first surface 112. A series of resilient protective pads 120 placed on the arm 116 provide a frictional grip to further secure the secured paper and prevent the arm from tearing the paper.

Turning to FIG. 2, the second surface 122 of the main body 102 comprises a drawing guide, which is comprised of a series of raised portions as will be described in more detail below. A second securement clip 124 attached to the main body 102 near the top edge 104 is essentially identical to the first securement clip 114 as described above, including a generally U-shaped arm 126 attached to a base 128 having a spring mechanism which biases the arm 126 against the second surface 122, with a series of resilient protective pads 130 positioned along the arm.

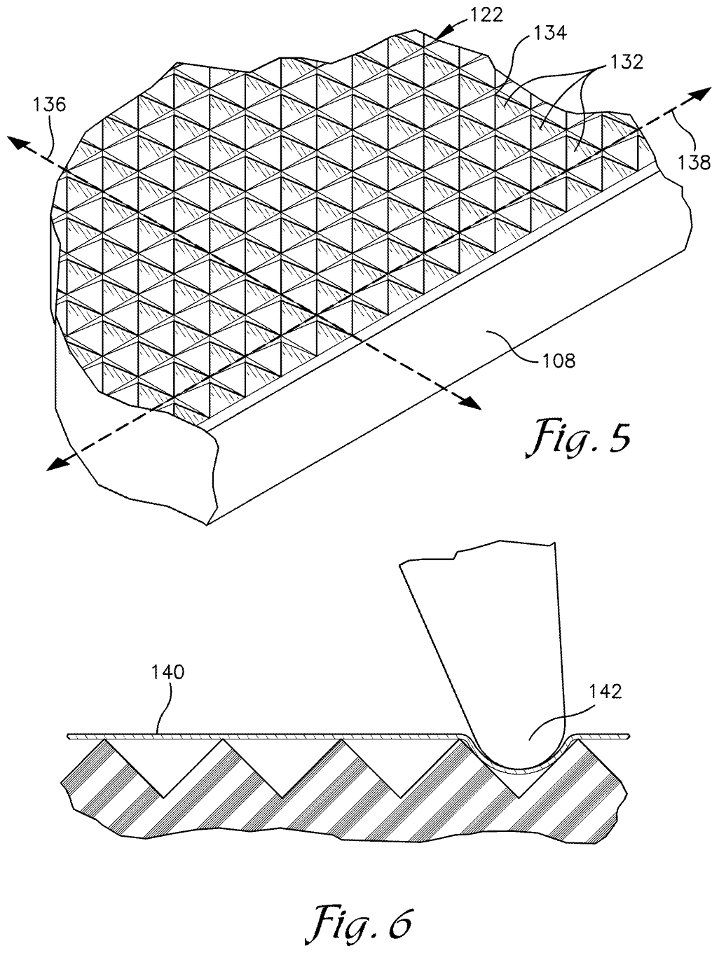

Turning to FIGS. 5 and 6, the second surface 122 of the main body 102 comprises a plurality of raised sections 132 arranged in an aligned grid pattern. Each raised section 132 is formed as a compressed four-sided pyramid, with an uppermost point 134 at the center of the square where the four sides meet, with each of the four sides of the pyramid side sloping downwardly to a corresponding bottom edge. With the raised sections arranged in a grid pattern, horizontal 136 and vertical 138 line paths are formed between the adjacent raised sections. As seen in FIGS. 5 and 6, with a piece of paper 140 placed over the second surface 122, the point 142 or tip of a writing instrument presses the paper into the recessed line path formed by the adjacent sections.

By moving the writing instrument along the horizontal 136 or vertical 138 line path, the user draws a straight line of a desired length onto the paper, with the line paths guiding the tip of the writing instrument as it moves along the paper. Thus, a user is able to draw straight horizontal and vertical lines or line segments as required to form lines, grids, boxes, and the like. The drawing guide and line paths thus allow a user to accurately and quickly draw straight lines, parallel lines, angled lines, etc. with precision and accuracy not possible when free-hand drawing on a hand-held clipboard.

As seen in FIGS. 1 and 2, it should be understood that a user in possession of the double-sided clipboard of the present invention may quickly and easily move a piece of paper from the first surface 112 to the second surface 122 of the clipboard, and vice-versa, allowing them to write free-hand with the paper clipped to the first surface 112, and to draw precise lines by simply unclipping the paper and switching it to the second surface Thus, unlike single sided clipboards and drawing grids known in the art, there is no need to find a separate surface for writing on the paper such as is the case when using a drawing grid as currently exists in the art.

It should be further understood that while the clipboard depicted in the exemplary embodiment includes a line drawing grid, that other drawing assistance features may likewise be formed in the second surface. For example, a portion of the second surface may include recessed portions defining circles, triangles, or other shapes, or may include recessed lettering guides that can be used to draw or trace those corresponding shapes or letters. Alternative grid arrangements to allow, for example, drawing diagonal lines, are also within the scope of the present invention.

In further alternative embodiments, each side of the clipboard may include one or more securement clips, for example, securement clips at the top and bottom of the board, or clips along the side of the board to provide further securement of a paper or form. In further embodiments, one side of the board may include a plurality of securement clips, with the other side having no securement clips. These and other variations are within the scope of the present invention.

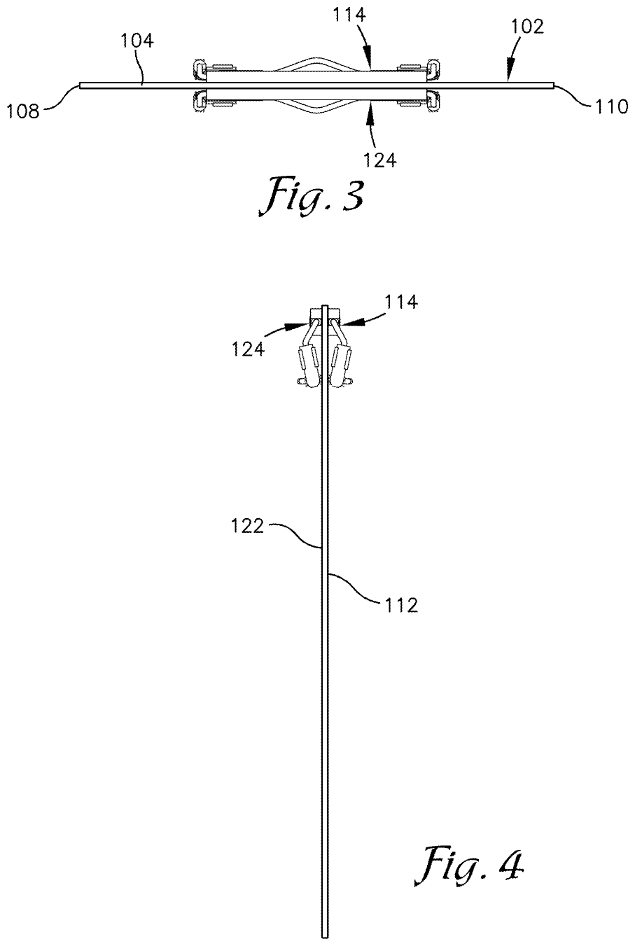

Looking to FIG. 3, a top end view of the clipboard of FIG. 1 shows the first and second securement clips positioned on opposite sides of the main body. Similarly, FIG. 4 depicts the securement clips on opposite sides of the main body viewed from a side edge of the clipboard.

While the embodiment shown depicts a flat surface for writing and a line grid surface for drawing line, it should be understood that other combinations of surfaces are contemplated by and within the scope of the present invention. For example, in an alternative embodiment, the double-sided clipboard may include two smooth surfaces. Thus, in that embodiment a user may attach a sheet or tablet of paper to each and use each side for writing. Or, a user may attach a copy of a form or checklist he or she is using to one side of the clipboard and attach a writing sheet for taking notes to the other side. In other exemplary embodiments, the double-sided clipboard may include differing line grids on the two sides of the clipboard. For example, a line grid allowing drawing of horizontal and vertical lines may be formed on one side of the clipboard, with a line grid allowing drawing diagonal lines on the other side. Or, one side of the clipboard may include a formed lettering guide, or a guide to allow drawing other shapes. These and other combinations of surfaces are within the scope of the present invention.

It is to be understood that while certain forms of the present invention have been illustrated and described herein, it is not to be limited to the specific forms or arrangement of parts described and shown.

1. A double-sided clipboard, comprising:
a main body portion comprising first and second surfaces; and
first and second securement clips attached to the first and second surfaces, respectively, wherein each securement clip is configured to removably secure drawing or writing material to the corresponding surface.

2. The double-sided clipboard of claim 1, wherein the first surface comprises a generally smooth writing surface and the second surface comprises a drawing guide.

3. The double-sided clipboard of claim 2, wherein the drawing guide comprises formed raised and recessed areas for guiding a tip of a writing instrument.

4. The double-sided clipboard of claim 3, wherein the formed raised and recessed areas in the second surface are arranged in a grid pattern and define a plurality of horizontal and vertical line guides.

5. The double-sided clipboard of claim 3, wherein the formed raised and recessed areas in the second surface define line guides for drawing geometric shapes.

6. The double-sided clipboard of claim 1, wherein each of said first and second securement clips is spring biased against the respective first and second surfaces.

7. The double-sided clipboard of claim 1, wherein the first and second surfaces each comprise a generally smooth writing surface.

8. The double-sided clipboard of claim 1, wherein the first and second surfaces each comprise a drawing guide.

9. A double-sided clipboard, comprising:
a main body portion comprising first and second opposed surfaces, wherein the first surface comprises a generally smooth writing surface and the second surface comprises a drawing guide; and
a plurality of securement clips attached to the first and second surfaces, wherein each securement clip is configured to removably secure a portion of a writing material to the corresponding surface.

10. The double-sided clipboard of claim 9, wherein the drawing guide comprises formed raised and recessed areas for guiding a tip of a writing instrument.

11. The double-sided clipboard of claim 10, wherein the formed raised and recessed areas in the second surface are arranged in a grid pattern and define a plurality of horizontal and vertical line guides.

12. The double-sided clipboard of claim 11, wherein the formed raised and recessed areas in the second surface define line guides for drawing geometric shapes.

13. The double-sided clipboard of claim 10, wherein each of said plurality of securement clips is spring biased against the respective first and second surfaces.

14. The double-sided clipboard of claim 10, wherein the first and second surfaces each comprise a generally smooth writing surface.

15. The double-sided clipboard of claim 10, wherein the first and second surfaces each comprise a drawing guide.
